(19) United States
(12) Patent Application Publication
(10) Pub. No.: US 2025/0298887 A1
(43) Pub. Date: Sep. 25, 2025

(54) PROGRAM IDENTIFICATION METHOD AND PROGRAM IDENTIFICATION DEVICE

(71) Applicant: Panasonic Intellectual Property Management Co., Ltd., Osaka (JP)

(72) Inventors: Tatsumi OBA, Chiba (JP); Hiroyuki OKADA, Osaka (JP)

(73) Assignee: Panasonic Intellectual Property Management Co., Ltd., Osaka (JP)

(21) Appl. No.: 19/228,225

(22) Filed: Jun. 4, 2025

Related U.S. Application Data
(63) Continuation of application No. PCT/JP2023/040751, filed on Nov. 13, 2023.
(60) Provisional application No. 63/432,205, filed on Dec. 13, 2022.

(30) Foreign Application Priority Data
Jun. 6, 2023 (JP) 2023-093513

(51) Int. Cl. G06F 21/55; G06N 20/00

(52) U.S. Cl. CPC G06F 21/552; G06N 20/00; G06F 2221/033

(57) ABSTRACT

A program identification method includes: (i) obtaining a machine learning model generated through training with use of labeled training data including first feature vectors and identification information items each indicating whether a first program is malicious, and each of the first feature vectors is expressed in a first format indicating whether each of first functions of a program in a first language is to be used by the first program; (ii) generating a second feature vector expressed in a second format indicating whether each of second functions of a program in a second language is to be used by a second program; (iii) converting the format of the second feature vector into the first format; and (iv) outputting an identification result indicating whether the second program is malicious, where the identification result is obtained by inputting, to the machine learning model, the second feature vector whose format has been converted.

### CROSS REFERENCE TO RELATED APPLICATIONS

This is a continuation application of PCT International Application No. PCT/JP2023/040751 filed on Nov. 13, 2023, designating the United States of America, which is based on and claims priority of Japanese Patent Application No. 2023-093513 filed on Jun. 6, 2023 and U.S. Provisional Patent Application No. 63/432,205 filed on Dec. 13, 2022. The entire disclosures of the above-identified applications, including the specifications, drawings and claims are incorporated herein by reference in their entirety.

### FIELD

The present disclosure relates to a program identification method and a program identification device.

### BACKGROUND

Open-source software may be contaminated with malicious (anomalous) code. Non-Patent Literature (NPL) 1 discloses a technique of using machine learning to detect software contaminated with malicious code.

### Citation List

### Non Patent Literature

NPL 1: Ke Xu et al., “DroidEvolver: Self-Evolving Android Malware Detection System”, 2019 IEEE European Symposium on Security and Privacy (EuroS&P)
NPL 2: Trong Duc Nguyen et al., “Exploring API Embedding for API Usages and Applications”, 2017 IEEE/ACM 39th International Conference on Software Engineering

### SUMMARY

### Technical Problem

The present disclosure provides a program identification method and the like capable of accurately detecting a malicious program.

### Solution to Problem

A program identification method according to one aspect of the present disclosure includes: (i) obtaining a machine learning model generated through training with use of labeled training data indicating whether each of first programs is malicious, wherein (a) each of the first programs is expressed in a first language, (b) the machine learning model is generated through training with use of training data including first feature vectors and identification information items, where each of the first feature vectors is obtained by extracting a feature of a different one of the first programs, and each of the identification information items indicates whether a corresponding one of the first programs is malicious, and (c) each of the first feature vectors is expressed in a first format indicating whether each of first functions of a program expressed in the first language is to be used by the corresponding one of the first programs; (ii) generating a second feature vector by extracting a feature of a second program expressed in a second language different from the first language, where the second feature vector is expressed in a second format indicating whether each of second functions of a program expressed in the second language is to be used by the second program; (iii) converting the format of the second feature vector generated into the first format; and (iv) outputting an identification result indicating whether the second program is malicious, where the identification result is obtained by inputting, to the machine learning model, the second feature vector whose format has been converted into the first format.

A program identification device according to one aspect of the present disclosure includes: a processor; and memory. Using the memory, the processor: (i) obtains a machine learning model generated through training with use of labeled training data indicating whether each of first programs is malicious, wherein (a) each of the first programs is expressed in a first language, (b) the machine learning model is generated through training with use of training data including first feature vectors and identification information items, where each of the first feature vectors is obtained by extracting a feature of a different one of the first programs, and each of the identification information items indicates whether a corresponding one of the first programs is malicious, and (c) each of the first feature vectors is expressed in a first format indicating whether each of first functions of a program expressed in the first language is to be used by the corresponding one of the first programs; (ii) generates a second feature vector by extracting a feature of a second program expressed in a second language different from the first language, wherein the second feature vector is expressed in a second format indicating whether each of second functions of a program expressed in the second language is to be used by the second program; (iii) converts the format of the second feature vector generated into the first format; and (iv) outputs an identification result indicating whether the second program is malicious, where the identification result is obtained by inputting, to the machine learning model, the second feature vector whose format has been converted into the first format.

These general or specific aspects of the present disclosure may be implemented using a system, a device, an integrated circuit, a computer program, or a computer-readable non-transitory recording medium such as a CD-ROM, or any combination of methods, devices, systems, integrated circuits, computer programs, and non-transitory recording media.

### Advantageous Effects

The program identification method and the like according to the present disclosure enable accurately detecting a malicious program.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a block diagram illustrating one example of the configuration of a program identification device according to an embodiment.

FIG. 2 is a diagram for describing a first feature vector.

FIG. 3 is a diagram for describing a part of correspondence.

FIG. 4 is a diagram for describing another part of the correspondence.

FIG. 5 is a flowchart illustrating one example of training processing by the program identification device.

FIG. 6 is a flowchart illustrating one example of identification processing by the program identification device.

FIG. 7 is information illustrating one example of first malicious information.

FIG. 8 is a diagram for describing a method of calculating similarity between a second program and each first program.

FIG. 9 is a flowchart illustrating one example of processing of specifying a first program similar to the second program.

### DESCRIPTION OF EMBODIMENT

### Underlying Knowledge Forming Basis of the Present Disclosure

Conventional techniques such as the one mentioned above are effective for a programming language that has a large amount of source code written in that language and provided with label information indicating whether code is benign or malicious. For such a programming language, a machine learning model generated by supervised learning can be used to accurately detect a program containing anomalous source code (hereinafter referred to as a malicious program).

Unfortunately, for a programming language having a small amount of label information, accurate detection of a malicious program is difficult because of inability to perform sufficient supervised learning.

In view of the above, the present disclosure provides a program identification method and the like capable of accurately detecting a malicious program.

A program identification method according to a first aspect of the present disclosure includes: (i) obtaining a machine learning model generated through training with use of labeled training data indicating whether each of first programs is malicious, wherein (a) each of the first programs is expressed in a first language, (b) the machine learning model is generated through training with use of training data including first feature vectors and identification information items, where each of the first feature vectors is obtained by extracting a feature of a different one of the first programs, and each of the identification information items indicates whether a corresponding one of the first programs is malicious, and (c) each of the first feature vectors is expressed in a first format indicating whether each of first functions of a program expressed in the first language is to be used by the corresponding one of the first programs; (ii) generating a second feature vector by extracting a feature of a second program expressed in a second language different from the first language, where the second feature vector is expressed in a second format indicating whether each of second functions of a program expressed in the second language is to be used by the second program; (iii) converting the format of the second feature vector generated into the first format; and (iv) outputting an identification result indicating whether the second program is malicious, where the identification result is obtained by inputting, to the machine learning model, the second feature vector whose format has been converted into the first format.

Thus, the machine learning model, obtained by machine learning regarding whether the first programs expressed in the first language are malicious, can be used to identify whether the second program expressed in the second language is malicious. As such, for example, a machine learning model trained on programs expressed in a programming language having a large amount of label information can be used to identify whether a program expressed in a programming language having a small amount of label information is malicious. This allows accurate identification of a malicious program.

A program identification method according to a second aspect of the present disclosure is the program identification method according to the first aspect of the present disclosure, and in the converting, the format of the second feature vector is converted into the first format using a correspondence between the first functions and the second functions.

This allows readily converting the format of the second feature vector into the format of the first feature vectors. Thus, whether the second program is malicious can be accurately identified using the machine learning model trained on the programs in the programming language different from the programming language of the second program.

A program identification method according to a third aspect of the present disclosure is the program identification method according to the second aspect of the present disclosure, and the correspondence indicates that one first function among the first functions is associated with one second function among the second functions.

This allows readily converting the format of the second feature vector into the format of the first feature vectors.

A program identification method according to a fourth aspect of the present disclosure is the program identification method according to the third aspect of the present disclosure, and the correspondence indicates that other two or more first functions among the first functions excluding the one first function are associated with one other second function among the second functions excluding the one second function.

This allows readily converting the format of the second feature vector into the format of the first feature vectors if other two or more of the first functions correspond to another one of the second functions.

A program identification method according to a fifth aspect of the present disclosure is the program identification method according to the fourth aspect of the present disclosure, and the correspondence includes a weight of the one other second function assigned for the other two or more first functions.

This allows readily converting the format of the second feature vector into the format of the first feature vectors, depending on the relationship of the other second function with each of the two or more first functions.

A program identification method according to a sixth aspect of the present disclosure is the program identification method according to the second aspect of the present disclosure, and the correspondence indicates a similarity between a vector representation of each of the first functions and a vector representation of each of the second functions.

This allows readily converting the format of the second feature vector into the format of the first feature vectors.

A program identification method according to a seventh aspect of the present disclosure is the program identification method according to any one of the first aspect to the sixth aspect of the present disclosure, and further includes: obtaining, for each of one or more first programs indicated as being malicious by the labeled training data, first malicious information including one or more first malicious contributions respectively corresponding to one or more first functions indicated as being to be used by the first feature vector corresponding to the first program; obtaining second malicious information including one or more second malicious contributions respectively corresponding to one or more first functions indicated as being used by the second feature vector which corresponds to a second program indicated as being malicious by the identification result and whose format has been converted into the first format; specifying a first program corresponding to similar malicious information similar to the second malicious information by comparing the second malicious information with each of the one or more first malicious information items respectively corresponding to the one or more first programs obtained; and outputting information indicating the first program specified.

This allows specifying a first program having a feature similar to the feature of the second program.

A program identification method according to an eighth aspect of the present disclosure is the program identification method according to the seventh aspect of the present disclosure, and in the specifying, with use of M first malicious contributions selected in a descending order of contributions among the one or more first malicious contributions and M second malicious contributions selected in a descending order of contributions among the one or more second malicious contributions, where M is an integer greater than one, a similarity between the second malicious information and first malicious information to be compared is calculated and the similar malicious information is specified based on the similarity.

This can simplify the similarity calculation for specifying the similar malicious information.

A program identification device according to a ninth aspect of the present disclosure includes: a processor; and memory. Using the memory, the processor: (i) obtains a machine learning model generated through training with use of labeled training data indicating whether each of first programs is malicious, wherein (a) each of the first programs is expressed in a first language, (b) the machine learning model is generated through training with use of training data including first feature vectors and identification information items, where each of the first feature vectors is obtained by extracting a feature of a different one of the first programs, and each of the identification information items indicates whether a corresponding one of the first programs is malicious, and (c) each of the first feature vectors is expressed in a first format indicating whether each of first functions of a program expressed in the first language is to be used by the corresponding one of the first programs; (ii) generates a second feature vector by extracting a feature of a second program expressed in a second language different from the first language, wherein the second feature vector is expressed in a second format indicating whether each of second functions of a program expressed in the second language is to be used by the second program; (iii) converts the format of the second feature vector generated into the first format; and (iv) outputs an identification result indicating whether the second program is malicious, where the identification result is obtained by inputting, to the machine learning model, the second feature vector whose format has been converted into the first format.

Thus, the machine learning model, obtained by machine learning regarding whether the first programs expressed in the first language are malicious, can be used to identify whether the second program expressed in the second language is malicious. As such, for example, a machine learning model trained on programs expressed in a programming language having a large amount of label information can be used to identify whether a program expressed in a programming language having a small amount of label information is malicious. This allows accurate identification of a malicious program.

A recording medium according to a tenth aspect of the present disclosure is a non-transitory computer-readable recording medium for use in a computer, the recording medium having recorded thereon a program for causing the computer to execute the program identification method according to any one of the first aspect to the eighth aspect of the present disclosure.

Hereinafter, a program identification device according to an embodiment of the present disclosure will be described with reference to the drawings. Each of the exemplary embodiments described below shows an example of a preferred embodiment of the present disclosure. In other words, the numerical values, shapes, materials, elements, the arrangement and connection of the elements, steps, an order of the steps etc. shown in the following exemplary embodiments are mere examples, and therefore do not limit the essence of the present disclosure. The present disclosure is defined based on the scope of the claims. Therefore, among the elements in the following exemplary embodiments, those not recited in any one of the independent claims reciting the broadest concept are described as elements constituting a more preferred embodiment although not necessarily required to achieve the object of the present disclosure.

### EMBODIMENT

### 1. Configuration

A program identification device according to an embodiment identifies, using a machine learning model generated by supervised learning, whether a program expressed in a programming language different from the programming language of programs used for the supervised learning is malicious.

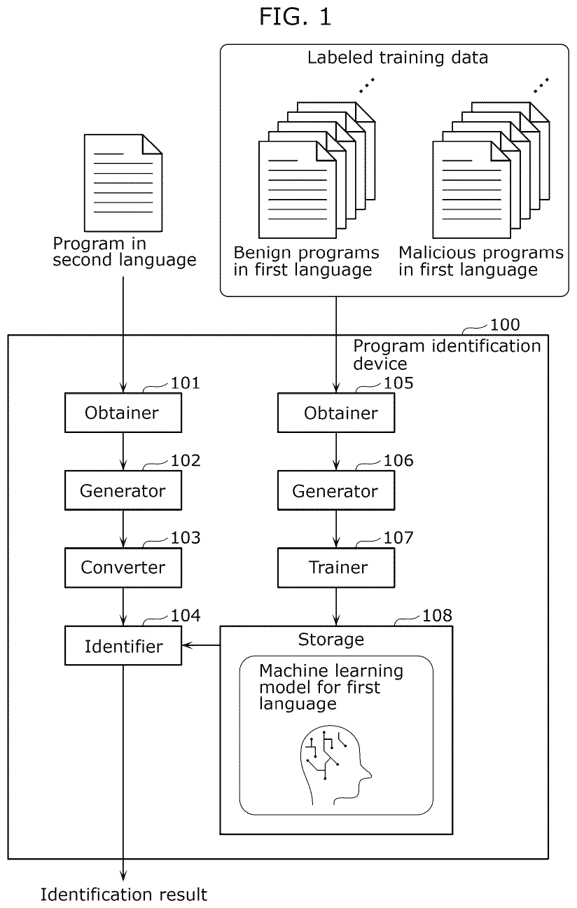

FIG. 1 is a block diagram illustrating one example of the configuration of the program identification device according to the embodiment.

To identify whether a program expressed in a second language is malicious, program identification device 100 uses a machine learning model obtained through training by the use of labeled training data that includes label information indicating whether each of programs expressed in a first language is malicious. The first language and the second language are different programming languages each other. Programs expressed in the first language will be referred to as first programs. Programs expressed in the second language will be referred to as second programs. First programs surpass second programs in, for example, the number of programs provided with label information.

Program identification device 100 includes obtainer 101, generator 102, converter 103, identifier 104, obtainer 105, generator 106, trainer 107, and storage 108. Note that program identification device 100 need not include obtainer 105, generator 106, trainer 107, and storage 108 if it has a function of obtaining a machine learning model obtained through training by the use of labeled training data that includes label information indicating whether each of programs expressed in the first language is malicious.

Here, the labeled training data used for the machine learning will be described.

The labeled training data includes: first feature vectors, each obtained by extracting features of a different one of the first programs; and identification information items, each indicating whether a corresponding one of the first programs is malicious. Each of the identification information items is an example of the label information. The identification information items correspond to the respective first programs. The first feature vectors correspond to the respective first programs. Each of the first feature vectors is expressed in a first format indicating whether each of first functions of programs expressed in the first language is used by the corresponding first program. The first format is common to the first programs different from each other. The first programs from which the first feature vectors are extracted may be expressed as source code or binary code.

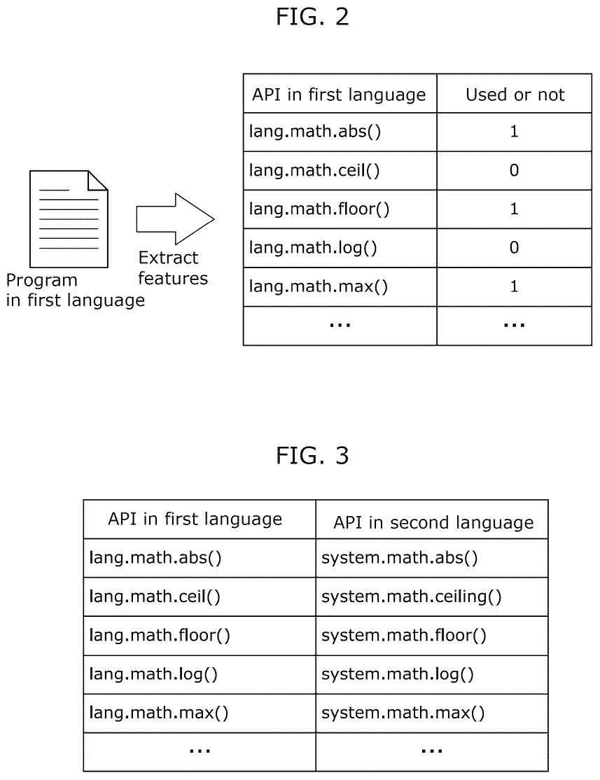

FIG. 2 is a diagram for describing a first feature vector.

For example, the first functions of programs expressed in the first language are represented as a list of Application Programming Interfaces (APIs) that may be used by programs expressed in the first language. As shown in FIG. 2, the first feature vector of a first program is information indicating whether each of the APIs that may be used by programs expressed in the first language is used by that first program. An API used by a first program is, for example, an API called in the first program. This list may include a group of APIs, called standard APIs, for programs expressed in the first language. In the example shown in FIG. 2, “0” indicates APIs not used, whereas “1” indicates APIs used. Thus, the first feature vector is a binary vector. APIs that may be used by programs expressed in the first language will be referred to as first APIs.

Referring again to FIG. 1, the components of program identification device 100 will be described.

Obtainer 101 obtains a second program to be identified as malicious or benign. Obtainer 101 may obtain one or more second programs. Each second program to be identified may be expressed as source code or binary code.

Generator 102 generates a second feature vector by extracting features of the second program. The second feature vector is expressed in a second format indicating whether each of second functions of programs expressed in the second language is used by the second program. The second format is common to the one or more second programs different from each other.

The second functions are represented as a list of Application Programming Interfaces (APIs) that may be used by programs expressed in the second language. That is, as with the first feature vectors described with reference to FIG. 2, the second feature vector of the second program is information indicating whether each of the APIs that may be used by programs expressed in the second language is used by the second program. An API used by the second program is, for example, an API called in the second program. This list may include a group of APIs, called standard APIs, for programs expressed in the second language. APIs that may be used by programs expressed in the second language will be referred to as second APIs.

Converter 103 converts the format of the generated second feature vector into the first format. Specifically, converter 103 uses correspondence between the first APIs and the second APIs to convert the format of the second feature vector into the first format. Conversion into the first format refers to converting the second feature vector into information indicating whether each of the first APIs that may be used by programs expressed in the first language is used by the second program. It can also be said that the conversion into the first format is the processing of mapping feature values extracted from the second program in the second language into the same space as feature values extracted from the first programs in the first language.

FIG. 3 is a diagram for describing a part of the correspondence.

As shown in FIG. 3, a part of the correspondence indicates that, for example, first APIs are associated with second APIs in a one-to-one correspondence. That is, the correspondence includes a first correspondence indicating that one of the first APIs is associated with one of the second APIs. Converter 103 converts the format of the second feature vector into the first format by considering that the use of a second API in the second feature vector corresponds to the use of the first API associated with the second API in a first correspondence. As an example, if the use of a second API is indicated as “1,” converter 103 sets “1” as use information on the first API associated with the second API in a first correspondence. As another example, if the use of a second API is indicated as “0,” converter 103 sets “0” as use information on the first API associated with the second API in a first correspondence. Thus, the second feature vector is a binary vector.

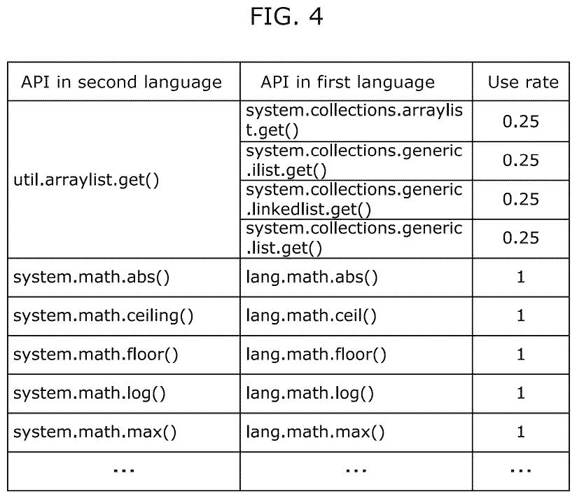

FIG. 4 is a diagram for describing another part of the correspondence.

As shown in FIG. 4, another part of the correspondence indicates that, for example, a second API is associated with multiple first APIs. That is, the correspondence includes a second correspondence indicating that other two or more of the first APIs are associated with another one of the second APIs. The two or more first APIs may each be assigned a use rate (weight) with respect to the second API with which the two or more first APIs are associated in the second correspondence. That is, the second correspondence may include weights of the second API assigned to the two or more first APIs.

For example, a second correspondence may indicate that four first APIs are associated with one second API and that the use of the one second API corresponds to the use of the four first APIs, each at a rate of 0.25. Thus, a second correspondence may indicate that, for N first APIs associated with one second API, the use of the one second API corresponds to the use of the N first APIs, each at a rate of 1/N. Although the example in FIG. 4 illustrates assigning the equal weight to the four first APIs, the four first APIs may be assigned different weights depending on their degrees of similarity to the second API. In that case, first APIs with higher degrees of similarity to the second API are assigned larger values of weight.

As an example, if the use of a second API is indicated as “1,” converter 103 sets “0.25” as use information on each of the four first APIs associated with the second API in a second correspondence. As another example, if the use of a second API is indicated as “0,” converter 103 sets “0” as use information on each of the four first APIs associated with the second API in a second correspondence.

Note that FIG. 4 illustrates correspondence including multiple first correspondences and one second correspondence.

As shown in FIGS. 3 and 4, the correspondence may be an API conversion table indicating which second-language APIs are associated with first-language APIs.

The correspondence may include a third correspondence indicating that one of the first APIs is associated with two or more of the second APIs.

The correspondence may include a combination of first, second, and third correspondences.

In NPL 2, APIs that may be used in Java JDK and APIs that may be used in C #. NET are visualized by converting the APIs into vector representations 10 using a technique called API2vec.

Converter 103 can convert similar APIs among vector representations 10 obtained using API2vec into close vector representations 10. This allows converter 103 to determine, among vector representations 10 of APIs in the target language, APIs closest to vector representations 10 of APIs in the source language, using, for example, the nearest neighbor method. In addition to the nearest neighbor method, methods for determining APIs similar to vector representations 10 of APIs in the source language may include a method that uses K nearest neighbors and a method that extracts features distributed among multiple APIs depending on the distances to the source-language APIs.

Thus, the correspondence may indicate similarity between vector representations 10 of the first APIs and vector representations 10 of the second APIs.

Identifier 104 outputs an identification result indicating whether the second program is malicious; the identification result is obtained by inputting, to the machine learning model, the second feature vector whose format has been converted into the first format. Identifier 104 obtains the machine learning model from storage 108.

Obtainer 105 obtains labeled training data.

Generator 106 generates first feature vectors, each generated by extracting features of a different one of first programs. Generator 106 outputs, to trainer 107, training information that includes: the first feature vectors; and identification information items, each identification information item indicating whether a corresponding one of the first programs is malicious.

Trainer 107 generates a machine learning model through training by the use of the training information. The trainer 107 stores the generated machine learning model in storage 108. The training by trainer 107 may use any technique used in supervised learning, for example logistic regression.

Storage 108 stores the machine learning model generated by trainer 107.

As mentioned above, obtainer 105, generator 106, trainer 107, and storage 108 need not be included in program identification device 100 and may instead be included in an external device communicatively connected to program identification device 100. In that case, program identification device 100 obtains the machine learning model from the external device.

### 2. Operation

Now, operations of program identification device 100 according to the embodiment will be described.

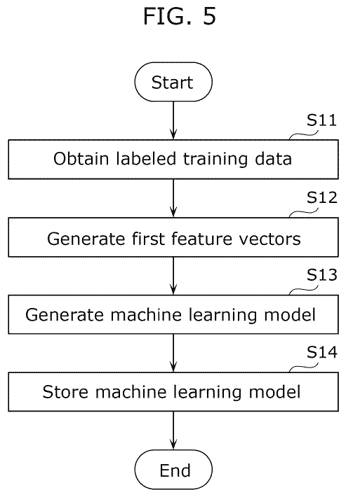

First, training processing by program identification device 100 will be described. FIG. 5 is a flowchart illustrating one example of training processing by the program identification device.

Program identification device 100 obtains labeled training data (S11). Step S11 is processing by obtainer 105.

Program identification device 100 generates first feature vectors, each generated by extracting features of a different one of first programs (S12). This yields training information that includes: the first feature vectors; and identification information items, each identification information item indicating whether a corresponding one of the first programs is malicious. Step S12 is processing by generator 106.

Program identification device 100 generates a machine learning model through training by the use of the training information (S13). Step S13 is processing by trainer 107.

Program identification device 100 stores the generated machine learning model in storage 108 (S14). Step S14 is processing by trainer 107 using storage 108.

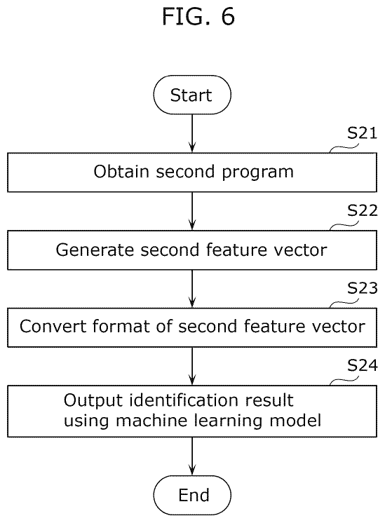

Next, identification processing on a second program by program identification device 100 will be described. FIG. 6 is a flowchart illustrating one example of identification processing by the program identification device.

Program identification device 100 obtains a second program to be identified as malicious or benign (S21). Step S21 is processing by obtainer 101.

Program identification device 100 generates a second feature vector by extracting features of the second program (S22). Step S22 is processing by generator 102.

Program identification device 100 converts the format of the generated second feature vector from a second format into a first format (S23). Step S23 is processing by converter 103.

Program identification device 100 outputs an identification result indicating whether the second program is malicious; the identification result is obtained by inputting, to the machine learning model, the second feature vector whose format has been converted into the first format (S24). Step S24 is processing by identifier 104.

### 3. Advantageous Effects, etc.

Program identification device 100 according to the embodiment performs a program identification method. First, the program identification method obtains a machine learning model generated through training by the use of labeled training data indicating whether each of first programs is malicious (S21). Here, each of the first programs is expressed in a first language. The labeled training data includes: first feature vectors, each obtained by extracting features of a different one of the first programs; and identification information items, each indicating whether a corresponding one of the first programs is malicious. Each of the first feature vectors is expressed in a first format indicating whether each of first functions of programs expressed in the first language is used by the corresponding first program. The program identification method then generates a second feature vector by extracting features of a second program expressed in a second language different from the first language (S22). Here, the second feature vector is expressed in a second format indicating whether each of second functions of programs expressed in the second language is used by the second program. Program identification method then converts the format of the generated second feature vector into the first format (S23), and outputs an identification result indicating whether the second program is malicious; the identification result is obtained by inputting, to the machine learning model, the second feature vector whose format has been converted into the first format (S24).

Thus, the machine learning model, obtained by machine learning regarding whether the first programs expressed in the first language are malicious, can be used to identify whether the second program expressed in the second language is malicious. As such, for example, a machine learning model trained on programs expressed in a programming language having a large amount of label information can be used to identify whether a program expressed in a programming language having a small amount of label information is malicious. This allows accurate identification of a malicious program.

In program identification device 100 according to the embodiment, the conversion involves converting the format of the second feature vector into the first format using correspondence between first APIs (first functions) and second APIs (second functions).

This allows readily converting the format of the second feature vector into the format of the first feature vectors. Thus, whether the second program is malicious can be accurately identified using the machine learning model trained on the programs in the programming language different from the programming language of the second program.

In program identification device 100 according to the embodiment, the correspondence indicates that one of the first APIs (first functions) is associated with one of the second APIs (second functions).

This allows readily converting the format of the second feature vector into the format of the first feature vectors.

In program identification device 100 according to the embodiment, the correspondence indicates that other two or more of the first APIs (first functions) are associated with another one of the second APIs (second functions).

This allows readily converting the format of the second feature vector into the format of the first feature vectors if other two or more of the first APIs correspond to another one of the second APIs.

In program identification device 100 according to the embodiment, the correspondence includes weights of the other second API (second function) assigned to the other two or more first APIs (first functions).

This allows readily converting the format of the second feature vector into the format of the first feature vectors, depending on the relationship of the other second API with each of the two or more first APIs.

In program identification device 100 according to the embodiment, the correspondence indicates similarity between a vector representation of each of the first APIs (first functions) and a vector representation of each of the second APIs (second functions).

This allows readily converting the format of the second feature vector into the format of the first feature vectors.

### 4. Variations

Program identification device 100 according to the above embodiment may further specify, among the first programs used for the training and labeled as malicious by the label information, a first program similar to the second program identified as malicious. The following will describe a configuration for performing the processing of specifying a first program similar to the second program identified as malicious. This configuration is implemented by the components of program identification device 100.

Through the machine learning described in the embodiment, trainer 107 generates first malicious information for each of the one or more first programs labeled as malicious by the labeled training data. The first malicious information for each malicious first program includes one or more first malicious contributions of the respective one or more first APIs indicated as being used by the first feature vector corresponding to the first program. Thus, the first malicious information is obtained.

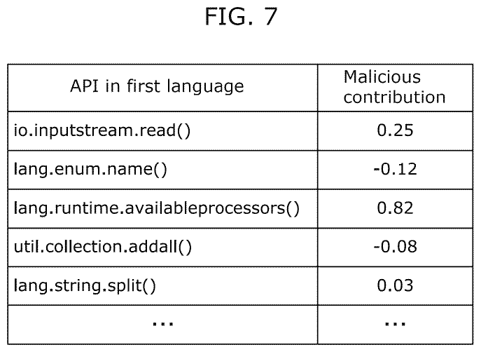

FIG. 7 is information illustrating one example of the first malicious information.

As shown in FIG. 7, the first malicious information includes first malicious contributions of the respective first APIs that may be used by programs expressed in the first language. The first malicious contributions are calculated when the machine learning model is generated.

Identifier 104 generates second malicious information that includes one or more second malicious contributions of the respective one or more first APIs indicated as being used by the second feature vector. The second feature vector corresponds to the second program identified as malicious in the output identification result, and has its format converted into the first format. Thus, the second malicious information is obtained.

The second malicious information corresponds to the second feature vector whose format has been converted into the first format. Therefore, as with the first malicious information described with reference to FIG. 7, it includes second malicious contributions of the respective first APIs that may be used by programs expressed in the first language. The second malicious contributions are calculated when the second feature vector whose format has been converted into the first format is input to the machine learning model.

Identifier 104 compares the second malicious information with each of the one or more obtained first malicious information items corresponding to the one or more first programs, thereby specifying a first program corresponding to similar malicious information similar to the second malicious information. Specifically, in specifying, identifier 104 selects M first malicious contributions (M is an integer greater than one) in descending order of contribution among the first malicious contributions, and M second malicious contributions in descending order of contribution among the second malicious contributions. Using the selected malicious contributions, identifier 104 calculates similarity between the second malicious information and each first malicious information item under comparison, thereby specifying similar malicious information based on the similarity.

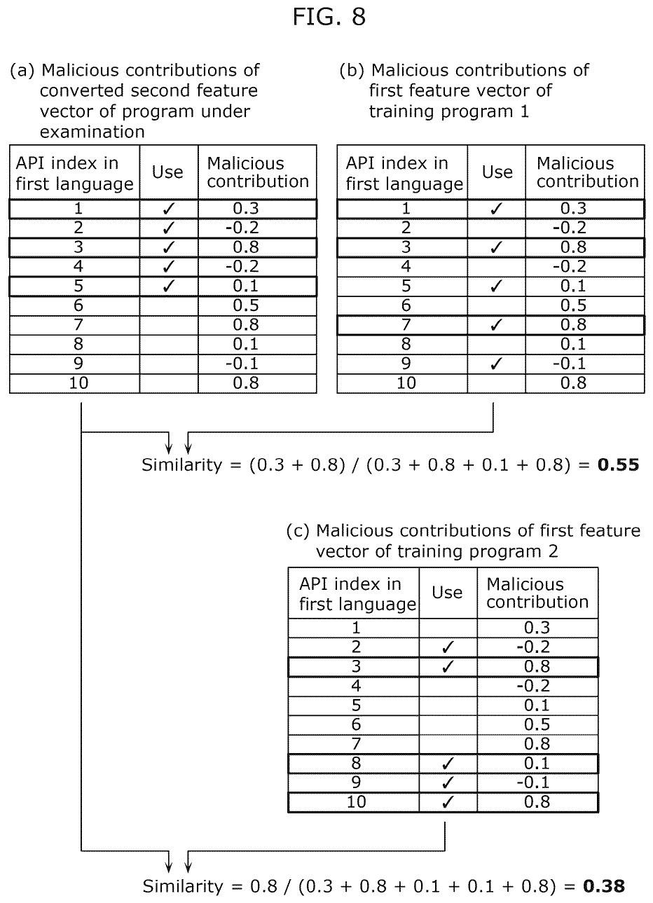

A specific example of calculating the similarity between the second program and each first program will be described with reference to FIG. 8.

FIG. 8 is a diagram for describing a method of calculating the similarity between the second program and each first program.

In FIG. 8, (a) illustrates the malicious contributions of the elements (APIs) of the converted second feature vector, (b) illustrates the malicious contributions of the elements (APIs) of the first feature vector of one of the malicious first programs (training program 1), and (c) illustrates the malicious contributions of the elements (APIs) of the first feature vector of another one of the malicious first programs (training program 2). That is, in FIG. 8, (a) illustrates an example of the second malicious information, whereas (b) and (c) illustrate examples of the first malicious information. The first malicious information and the second malicious information each include identification information identifying each first API, use information indicating whether the corresponding first API is used, and the malicious contribution of the corresponding first API.

Based on the second malicious information, identifier 104 determines three first APIs corresponding to three second malicious contributions selected in descending order of contribution among the malicious contributions of the first APIs used by the second program under examination. As the three first APIs, identifier 104 determines the first APIs indicated by the indexes 1, 3, and 5.

Based on the first malicious information on training program 1, identifier 104 determines three first APIs corresponding to three first malicious contributions selected in descending order of contribution among the malicious contributions of the first APIs used by training program 1. As the three first APIs, identifier 104 determines the first APIs indicated by the indexes 1, 3, and 7.

Identifier 104 calculates the sum of the malicious contributions corresponding to the indexes 1 and 3 (i.e., 0.3+0.8), which are included in the intersection of the set of the first APIs determined in the second malicious information and indicated by the indexes 1, 3, and 5, and the set of the first APIs determined in the first malicious information on training program 1 and indicated by the indexes 1, 3, and 7. Identifier 104 then calculates the sum of the malicious contributions corresponding to the indexes 1, 3, 5, and 7 (i.e., 0.3+0.8+0.1+0.8), which are included in the union of the set of the first APIs determined in the second malicious information and indicated by the indexes 1, 3, and 5, and the set of the first APIs determined in the first malicious information on training program 1 and indicated by the indexes 1, 3, and 7. Identifier 104 divides the sum of the malicious contributions in the intersection by the sum of the malicious contributions in the union. The resulting value is the calculated similarity between the second malicious information and the first malicious information under comparison. In this case, the similarity is calculated as 0.55.

Similarly, based on the first malicious information on training program 2, identifier 104 determines three first APIs corresponding to three first malicious contributions selected in descending order of contribution among the malicious contributions of the first APIs used by training program 2. As the three first APIs, identifier 104 determines the first APIs indicated by the indexes 3, 8, and 10.

Identifier 104 calculates the sum of the malicious contribution corresponding to the index 3 (i.e., 0.8), which is included in the intersection of the set of the first APIs determined in the second malicious information and indicated by the indexes 1, 3, and 5, and the set of the first APIs determined in the first malicious information of training program 2 and indicated by the indexes 3, 8, and 10. Identifier 104 then calculates the sum of the malicious contributions corresponding to the indexes 1, 3, 5, 8, and 10 (i.e., 0.3+0.8+0.1+0.1+0.8), which are included in the union of the set of the first APIs determined in the second malicious information and indicated by the indexes 1, 3, and 5, and the set of the first APIs determined in the first malicious information of training program 2 and indicated by the indexes 3, 8, and 10. Identifier 104 divides the sum of the malicious contribution in the intersection by the sum of the malicious contributions in the union. The resulting value is the calculated similarity between the second malicious information and the first malicious information under comparison. In this case, the similarity is calculated as 0.38.

Note that higher degrees of similarity are calculated as larger values.

If the calculated similarity is higher than a predetermined threshold, identifier 104 may specify, as a similar program similar to the second program, the first program with which the similarity has been calculated. Alternatively, identifier 104 may specify, as one or more similar programs similar to the second program, the top N first program(s) having the largest value(s) of similarity (N is an integer greater than zero).

Identifier 104 outputs information indicating the specified first program(s).

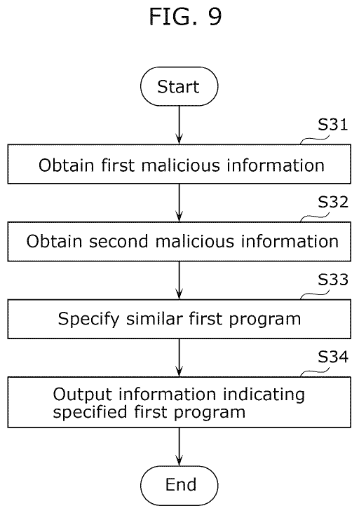

FIG. 9 is a flowchart illustrating one example of the processing of specifying a first program similar to the second program.

In addition to the processing performed by program identification device 100 according to the embodiment, program identification device 100 according to Variation 1 performs the following processing. For each of the one or more first programs labeled as malicious by the labeled training data, program identification device 100 obtains first malicious information that includes one or more first malicious contributions of the respective one or more first functions indicated as being used by the first feature vector corresponding to the first program (S31).

Program identification device 100 obtains second malicious information that includes one or more second malicious contributions of the respective one or more first functions indicated as being used by the second feature vector; the second feature vector corresponds to the second program identified as malicious in the identification result, and has its format converted into the first format (S32).

Program identification device 100 compares the second malicious information with each of the one or more obtained first malicious information items corresponding to the one or more first programs, thereby specifying a first program corresponding to similar malicious information similar to the second malicious information (S33).

Program identification device 100 outputs information indicating the specified first program (S34).

This allows outputting a first program having features similar to features of the second program.

In program identification device 100 according to the variation, the first malicious contributions are calculated when the machine learning model is generated. The second malicious contributions are calculated when the second feature vector whose format has been converted into the first format is input to the machine learning model.

Thus, the malicious contributions of the elements (APIs) of the feature vectors of the one or more first programs and the second program can be used to output a first program having features similar to features of the second program.

In program identification device 100 according to the variation, the specifying involves selecting M first malicious contributions (M is an integer greater than one) in descending order of contribution among the first malicious contributions, and M second malicious contributions in descending order of contribution among the second malicious contributions. The selected malicious contributions are used to calculate similarity between the second malicious information and each first malicious information item under comparison, thereby specifying similar malicious information based on the similarity.

This can simplify the similarity calculation for specifying the similar malicious information.

### Other Embodiments

In the foregoing embodiment, each constituent element of the program identification device may be configured by dedicated hardware or may be realized by executing a software program suitable for the constituent element. Each constituent element may be realized by a program executor such as a CPU or a processor reading out and executing a software program recorded onto a recording medium such as a hard disk or semiconductor memory.

Each constituent element may be a circuit (or an integrated circuit). These circuits may be included in a single circuit as a whole or may be separate circuits. Moreover, these circuits may be general purpose circuits or dedicated circuits.

General or specific aspects of the present disclosure may be implemented using a system, a device, a method, an integrated circuit, a computer program, or a computer-readable non-transitory recording medium such as a CD-ROM, or any combination of systems, devices, methods, integrated circuits, computer programs, and computer-readable non-transitory recording media.

For example, the present disclosure may be realized as a program identification method to be executed by a program identification device (computer or DSP), or as a program for causing the computer or DSP to execute the program identification method described above.

In the foregoing embodiment, a process executed by a specific processing unit may be executed by a different processing unit. An order of processes in the operation of the program identification device described in the foregoing embodiment may be changed or the processes may be executed in parallel.

Other embodiments obtained by various modifications to any of the embodiments which may be conceived by those skilled in the art or forms achieved by arbitrarily combining elements and functions in each of the embodiments may be also included in the present disclosure so long as they do not depart from the essence of the present disclosure.

### Industrial Applicability

The present disclosure is useful as a program identification method and the like capable of accurately detecting a malicious program.

1. A program identification method comprising:
(i) obtaining a machine learning model generated through training with use of labeled training data indicating whether each of first programs is malicious, wherein:
each of the first programs is expressed in a first language;
the machine learning model is generated through training with use of training data including first feature vectors and identification information items, each of the first feature vectors being obtained by extracting a feature of a different one of the first programs, each of the identification information items indicating whether a corresponding one of the first programs is malicious; and
each of the first feature vectors is expressed in a first format indicating whether each of first functions of a program expressed in the first language is to be used by the corresponding one of the first programs;
(ii) generating a second feature vector by extracting a feature of a second program expressed in a second language different from the first language, wherein
the second feature vector is expressed in a second format indicating whether each of second functions of a program expressed in the second language is to be used by the second program;
(iii) converting a format of the second feature vector generated into the first format; and
(iv) outputting an identification result indicating whether the second program is malicious, the identification result being obtained by inputting, to the machine learning model, the second feature vector whose format has been converted into the first format.

2. The program identification method according to claim 1, wherein
in the converting, the format of the second feature vector is converted into the first format using a correspondence between the first functions and the second functions.

3. The program identification method according to claim 2, wherein
the correspondence indicates that one first function among the first functions is associated with one second function among the second functions.

4. The program identification method according to claim 3, wherein
the correspondence indicates that other two or more first functions among the first functions excluding the one first function are associated with one other second function among the second functions excluding the one second function.

5. The program identification method according to claim 4, wherein
the correspondence includes a weight of the one other second function assigned for the other two or more first functions.

6. The program identification method according to claim 2, wherein
the correspondence indicates a similarity between a vector representation of each of the first functions and a vector representation of each of the second functions.

7. The program identification method according to claim 1, further comprising:
obtaining, for each of one or more first programs indicated as being malicious by the labeled training data, first malicious information including one or more first malicious contributions respectively corresponding to one or more first functions indicated as being to be used by the first feature vector corresponding to the first program;
obtaining second malicious information including one or more second malicious contributions respectively corresponding to one or more first functions indicated as being used by the second feature vector which corresponds to a second program indicated as being malicious by the identification result and whose format has been converted into the first format;
specifying a first program corresponding to similar malicious information similar to the second malicious information by comparing the second malicious information with each of the one or more first malicious information items respectively corresponding to the one or more first programs obtained; and
outputting information indicating the first program specified.

8. The program identification method according to claim 7, wherein
in the specifying, with use of M first malicious contributions selected in a descending order of contributions among the one or more first malicious contributions and M second malicious contributions selected in a descending order of contributions among the one or more second malicious contributions, where M is an integer greater than one, a similarity between the second malicious information and first malicious information to be compared is calculated and the similar malicious information is specified based on the similarity.

9. A program identification device comprising:
a processor; and
memory, wherein
using the memory, the processor:
obtains a machine learning model generated through training with use of labeled training data indicating whether each of first programs is malicious, wherein:
each of the first programs is expressed in a first language;
the machine learning model is generated through training with use of training data including first feature vectors and identification information items, each of the first feature vectors being obtained by extracting a feature of a different one of the first programs, each of the identification information items indicating whether a corresponding one of the first programs is malicious; and
each of the first feature vectors is expressed in a first format indicating whether each of first functions of a program expressed in the first language is to be used by the corresponding one of the first programs;
generates a second feature vector by extracting a feature of a second program expressed in a second language different from the first language, wherein
the second feature vector is expressed in a second format indicating whether each of second functions of a program expressed in the second language is to be used by the second program;
converts a format of the second feature vector generated into the first format; and
outputs an identification result indicating whether the second program is malicious, the identification result being obtained by inputting, to the machine learning model, the second feature vector whose format has been converted into the first format.

10. A non-transitory computer-readable recording medium for use in a computer, the recording medium having recorded thereon a computer program for causing the computer to execute the program identification method according to claim 1.
